(19) United States
(12) Patent Application Publication
(10) Pub. No.: US 2016/0333156 A1
(43) Pub. Date: Nov. 17, 2016

(54) Composition and Method for Making a Flexible Packaging Film

(71) Applicant: Frito-Lay North America, Inc., Plano, TX (US)

(72) Inventors: Sonya D. BENSON, Burleson, TX (US); Sridevi NARAYAN-SARATHY, Frisco, TX (US); Brad Dewayne RODGERS, Frisco, TX (US)

(21) Appl. No.: 14/711,102

(22) Filed: May 13, 2015

(51) Int. Cl. C08J 5/18

(52) U.S. Cl. CPC C08J 5/18; C08J 2367/02; C08J 2397/02; C08J 2367/04; C08J 2467/02; C08J 2467/04; C08J 2497/02

(57) ABSTRACT

Composition and method for making a flexible polymer film highly loaded with at least one plant-based organic particulate filler, and optionally an inorganic filler.

### BACKGROUND OF THE INVENTION

1. Technical Field

The present invention relates to a flexible film material that can be used in products and to a method of making the flexible film.

2. Description of Related Art

Multi-layered film structures are often used in flexible packages where there is a need for advantageous barrier, sealant, and graphics-capability properties. Barrier properties in one or more layers are important in order to protect the product inside the package from light, oxygen or moisture. The sealant properties are important in order to enable the flexible package to form an airtight or hermetic seal. Without a hermetic seal, any barrier properties provided by the film are ineffective against oxygen, moisture, or aroma transmission between the product in the package and the outside. A graphics capability is needed because it enables a consumer to quickly identify the product that he or she is seeking to purchase, allows food product manufacturers a way to label the nutritional content of the packaged food, and enables pricing information, such as bar codes, to be placed on the product.

One known method of producing polymer films is the blown film extrusion process. Blown film is created by extruding molten polymer resin through an annular die. Gas is blown onto the polymer film ring to stretch it and create a bubble with expanded diameter. The bubble is then collapsed into a two-layer sheet by rollers, optionally slit, and wound onto a storage roller. Another known method of producing polymer films is the extrusion casting method, whereby polymer resin is cast into a thin film sheet, which may then be oriented in the machine and/or transverse directions.

### SUMMARY OF THE INVENTION

In one embodiment, a flexible polymer film comprises at least one layer, wherein said at least one layer comprises a polymer and at least 10% by weight of a plant-based organic particulate filler, wherein the plant-based organic particulate filler comprises a maximum particle size of 10 microns. In another embodiment, the at least one layer comprises at least 20% by weight of the organic particulate filler. In still another embodiment, the at least one layer comprises at least 30% by weight of the inorganic particulate filler. The plant-based organic particulate filler may comprise at least one of oat hulls, soy flakes, rice hulls, and coconut hulls.

In the flexible polymer film of any other embodiment disclosed herein, the at least one layer further comprises an inorganic particulate filler, wherein the inorganic particulate filler comprises at least one of talc, clays, silicon dioxide, diatamaceous earth, Kaolin, micas, gypsum, potassium nitrate, sodium chloride, metal chlorides, dolomite, bentonite, montmorillonite, metal sulfates, ammonium nitrate, sodium nitrate, titanium dioxides, and calcium carbonate. The inorganic particulate filler may comprise at least 10% by weight of the at least one layer.

In the flexible polymer film of any other embodiment disclosed herein, the polymer comprises a bio-based polymer. In other embodiments, the polymer comprises at least one of a poly lactic acid (PLA) polymer, a polyhydroxyalkanoate (PHA) polymer, or a polybutylene succinate (PBS) polymer.

In the flexible polymer film of any other embodiment disclosed herein, the at least one layer further comprises a polymer chain extender. The polymer chain extender may comprise an epoxy modified polymer.

The flexible polymer film may comprise a thickness of less than 2 mils. The flexible polymer film of claim 3 wherein said inorganic particulate filler comprises at least 10% by weight of said at least one layer.

### BRIEF DESCRIPTION OF THE FIGURES

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying figures, wherein:

FIG. 1 depicts one embodiment of a system for producing blown film; and

FIG. 2 depicts one embodiment of a system for producing extrusion cast film.

### DETAILED DESCRIPTION

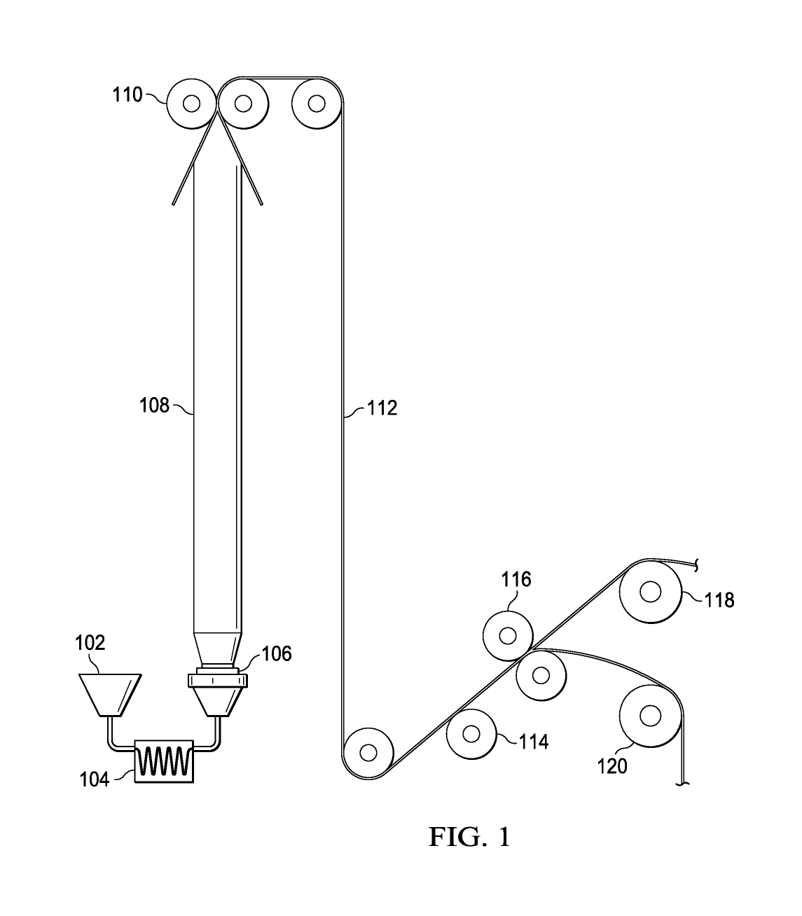

In one embodiment, the present invention is directed towards a blown film for use in a multi-layer flexible film package. FIG. 1 depicts one embodiment of a system, sometimes referred to as a high stalk blown film line, used to produce an example blown film of the present invention. Compounded polymer blends (including the inventive polymer blends discussed below), polymer resins, additives and other ingredients are combined in a hopper 102 and fed into an extruder 104. Inside the extruder, the ingredients are melted and mixed, and extruded through an annular die 106 (or ring die) as gas is blown onto the polymer film tube 108 exiting the die. The gas helps stretch and expand the diameter of the polymer tube 108. The polymer tube 108 is compressed and flattened between rollers 110 to produce a two-layered sheet 112. Sheets that have more than two layers can be produced This two-layered sheet 112 can then be wound onto a storage roller, or proceed to a slitting operation 114. The sheet 112 can be slit on one side and unfolded into a single-layered sheet approximately twice as wide as the two-layered sheet. Alternatively (as shown in FIG. 1), the sheet 112 can be slit on both sides, separated 116 into two single-layered sheets which each comprise a width approximately equal to the width of the two-layered sheet, and wound onto storage rollers 118 and 120.

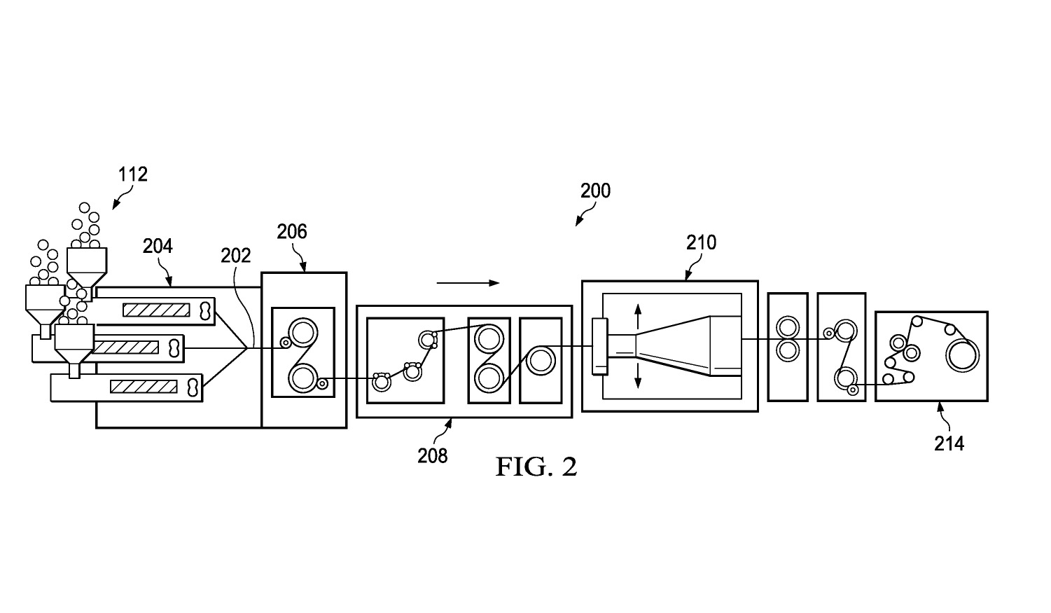

FIG. 2 depicts another example of a method of making a flexible polymer film of the present invention. In this example, three polymer resins, compounds or blends are fed as pellets 212 into an extrusion unit 204 where they are heated and co-extruded to form a multi-layer laminate composite film 202. The composite 202 is chilled on chill drums in a chilling unit 206, and then stretched (oriented) in the machine direction in a machine stretching unit 208. The composite film is typically stretched in the machine direction by running each successive roller at a faster speed than the previous roller. The machine stretched composite film is then stretched (oriented) in the transverse direction in a transverse stretching unit 210. The composite is typically stretched in the transverse direction using a “tenter” stretcher, which basically stretches the composite film between moving edge grips within a variable width frame as it travels through the transverse stretching unit 210, which is usually also heated to facilitate stretching. The biaxially oriented composite film is then optionally cut into sheets and stacked, rolled onto a storage roller (depicted as unit 214), or further processed, such as adding a barrier layer and/or combined with a graphics layer to make a film.

One of the main cost drivers in the production of blown or extrusion cast films is the cost of the raw materials input into the extruder. For example, some polymers, such as biodegradable or compostable polymers, which are more sustainable than olefin-based polymers, can be prohibitively expensive for use in packaging films intended for low-cost products. An alternative route to introducing sustainability into these structures is by the use of fillers derived from biomass that are renewable. Applicants herein propose to reduce the cost of the raw materials by substituting polymer with a high amount of plant-based organic particulate filler to make the film. The plant-based organic particulate filler displaces a significant portion of the polymer resin needed to create a blown or cast film. Non-limiting examples of plant-based organic particulate fillers include oat hulls, soy flakes, rice hulls, and coconut hulls. When such plant-based particulates are used, care should be taken to avoid negative effects on the organoleptic properties of the package, such as texture, odor and color.

One important characteristic of the plant-based organic particulate filler used herein is the particle size of the filler. In a preferred embodiment, substantially all of the particulate filler particles comprise a maximum particle size of about 10 microns. The term “substantially all” as used herein is intended to mean that the maximum particle size for the particulate filler is about 10 microns, subject to the practical and commercial reality that a very small but measurable number of particles may have a particle size that is larger than 10 microns. No particulate separation technique is absolutely perfect, and the intent is for as many particles as is commercially reasonable to be less than 10 microns in size. This small size enables practitioners to make thin films that are useful substitutes for existing packaging applications, including pillow-type bags and pouches. For example, oat hulls are produced as a waste product of a process used to make oatmeal and related products. These oat hulls comprise a particle size much larger than 10 microns, and it was a challenge for the Applicants herein to reduce the particle size of the particulate filler to less than 10 microns.

An example method that can be used to provide a plant-based organic particulate filler composition that has a maximum particle size of 10 microns is to use a combination of hammer milling and ball milling. These milling techniques or others can be used alone or in combination, as one skilled in the art will understand after reading this disclosure. Particulate aggregation is a problem that can occur during milling, especially when producing such fine particles. This challenge can be mitigated by coating particulates with stearic acid or similar chemicals during the milling process.

After the plant-based organic particulate filler particles are produced by a milling process, they must be dried before they can be used as an ingredient in a polymer compound. When compounded with a bio-based polymer, such as PLA, PHA or PBS (poly-butylene-succinate), the particles must be dried to a moisture content of less than 250 parts per million water. This drying process helps reduce particle agglomeration and prevents degradation of the polymer during compounding. Most bio-based polymer structures can be attacked and degraded in the presence of water at high temperatures (such as those encountered during the compounding process). One example of a drying process that can be used for oat hull particulates is passing them through a hot air oven at a temperature of about 125° F. for a residence time of about 12 hours.

In another embodiment, in addition to plant-based organic particulate fillers, one or more inorganic fillers may also be included in the polymer resin blend. Non-limiting examples of inorganic fillers include, but are not limited to talc, clays, silicon dioxide, diatamaceous earth, Kaolin, micas, gypsum, potassium nitrate, sodium chloride, metal chlorides, dolomite, bentonite, montmorillonite, metal sulfates, ammonium nitrate, sodium nitrate, titanium dioxides, and calcium carbonate.

The polymer compounding process is known in the art. Ingredients are fed into an extruder, which melts the polymer and blends it with any other components added into the extruder. The plant-based filler can be dry blended with the polymer resin prior to adding the components to the extruder or plant-based filler and the dry blended components can be added to the extruder via the same hopper. Alternatively, the polymer resin and plant-based filler can be added to the extruder via separate hoppers at different locations along the extruder. The plant-based filler can be fed into the extruder using vertical feeding hopper systems or horizontal side-stuffing hopper systems as well. The amount of filler added to the system can be added to the extruder by splitting the filler between a dry blend with the polymer resin and free filler added to extruder via a separate hopper. The extruder can also be vented to allow residual moisture from the plant-based filler and/or polymer resin to release to the atmosphere and facilitate the compounding process.

In some embodiments, chemical reactions between the added components can occur inside the extruder. The blended/reacted components are then passed through an extruder die orifice, cooled, and cut into pellets, each of which contains an approximately consistent product of the starting ingredients. The resulting compounded polymer pellets can then be used to make polymer films according to blown or cast production techniques in a similar way as previously known polymer compounds were used. Of course, the specific production parameters, such as temperature and pressure, need to be tailored to the application.

Furthermore, the compounded polymer pellets may need to be dried prior to their use as starting materials for thin films, depending on how long they have been stored. The plant-based organic particulate fillers will absorb water from the air during storage, which could compromise the thin film formation process. Drying can be accomplished using any method known in the art, and preferably occurs by passing the pellets through a hot air oven (in one embodiment, at an oven temperature of about 175° F. for a residence time of about 4 hours).

One optional ingredient or additive that can be added during the compounding process is a polymer chain extender. A polymer chain extender chemically reacts with the bio-based polymer resins linearly to increase the molecular weight of the polymer and/or crosslink different polymer chains and thereby increase the viscosity of the compounded polymer, which in turn provides a melt strength that helps produce high quality thin films. In a preferred embodiment, the chain extender is an epoxy-modified polymer, such as BASF Joncryl 3168. In another embodiment, the polymer chain extender is included at a weight percent of 1% or less.

### EXAMPLES

The table below provides information on several example inventive compounded polymer pellets produced according to various embodiments of the present invention.

TABLE 1
Example Inventive Polymer Compounds

| | Plant-based | Inorganic | | |
|---|---|---|---|---|
| Ex. | Organic Particulate | Filler | Polymer | Additive |
| No. | Filler (weight %) | (weight %) | (weight %) | (weight %) |
| 1 | Oat Hulls (40%) | None. | PBS (60%) | None. |
| 2 | Oat Hulls (50%) | None. | PBS (50%) | None. |
| 3 | Oat Hulls (30%) | None. | PBS (70%) | None. |
| 4 | Oat Hulls (40%) | None. | PBS (24%) | BASF Joncryl |
| | | | PLA (35%) | 3168 (1%) |
| 5 | Oat Hulls (20%) | Calcium | PBS (24%) | BASF Joncryl |
| | | Carbonate | PLA (35%) | 3168 (1%) |
| | | (20%) | | |

For each example polymer compound described in Table 1 above, the materials were added to a polymer compounding extruder at a rate of about 20 pounds per hour. The extruder contained 13 temperature zones, which were operated at temperatures that ranged from 160° F. to about 400° F. Because PBS melts at a lower temperature than PLA, the PBS-rich blends were at lower temperatures than the examples containing PLA. The plant-based organic particulate fillers described herein work especially well when compounded with bio-based polymer resins because such resins tend to melt at lower temperatures than other resins, such as polyolefins. The organic particulate fillers are, therefore, less likely to degrade during processing than they would be when processed at higher temperatures. The pressure at the extruder die face was between 1000 and 2000 psig in the example runs.

These example compounded polymer pellets were used to produce example blown films and cast films using the equipment described above. The example films have ranged in thickness between about 0.5 mils and 2 mils.

The flexible film of the present invention can be laminated onto one or more further layers of packaging film according to methods known in the art. For example, one or more core layers comprising a plant-based organic particulate filler described herein can be laminated with one or more skin layers, which can be used to promote metal adhesion, sealing, or other surface properties. Examples of skin layers include EAA (ethylene acrylic acid), EVOH (ethylene vinyl alcohol), Nylon, HDPE (high density polyethylene), LDPE (low density polyethylene), LLDPE (linear low density polyethylene), PGA (polyglycolic acid), or PBS (polybutyl styrene). The total thickness of a multilayered packaging film according to one embodiment of the present invention can range from 0.5 mils to 3.0 mils. Packaging film can then be used to create flexible product package using equipment, such as a vertical form fill seal (VFFS) machine, which are commercially available in the art.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

While this invention has been particularly shown and described with reference to a preferred embodiment, it will be understood by those skilled in the art that various changes in form and detail may be made therein without departing from the spirit and scope of the invention.

What is claimed is:

1. A flexible polymer film comprising:
at least one layer, wherein said at least one layer comprises a polymer and at least 10% by weight of a plant-based organic particulate filler, wherein the plant-based organic particulate filler comprises a maximum particle size of 10 microns.

2. The flexible polymer film of claim 1 wherein the plant-based organic particulate filler comprises at least one of oat hulls, soy flakes, rice hulls, and coconut hulls.

3. The flexible polymer film of claim 1 wherein said at least one layer further comprises an inorganic particulate filler, wherein said inorganic particulate filler comprises at least one of talc, clays, silicon dioxide, diatamaceous earth, Kaolin, micas, gypsum, potassium nitrate, sodium chloride, metal chlorides, dolomite, bentonite, montmorillonite, metal sulfates, ammonium nitrate, sodium nitrate, titanium dioxides, and calcium carbonate.

4. The flexible polymer film of claim 1 wherein said polymer comprises a bio-based polymer.

5. The flexible polymer film of claim 1 wherein said polymer comprises at least one of a poly lactic acid (PLA) polymer, a polyhydroxyalkanoate (PHA) polymer, or a polybutylene succinate (PBS) polymer.

6. The flexible polymer film of claim 1 further comprising a polymer chain extender.

7. The flexible polymer film of claim 6 wherein the polymer chain extender is an epoxy modified polymer.

8. The flexible polymer film of claim 1 further comprising a thickness of less than 2 mils.

9. The flexible polymer film of claim 3 wherein said inorganic particulate filler comprises at least 10% by weight of said at least one layer.

10. The flexible polymer film of claim 1 wherein the at least one layer comprises at least 20% by weight of the plant-based organic particulate filler.

11. The flexible polymer film of claim 1 wherein the at least one layer comprises at least 30% by weight of the plant-based organic particulate filler.
